(19) United States
(12) Patent Application Publication
(10) Pub. No.: US 2005/0077005 A1
(43) Pub. Date: Apr. 14, 2005

(54) Method for fabricating electro-optic light modulator

(75) Inventors: Xianhai Chen, San Jose, CA (US); David Baldwin, Atascadero, CA (US); Alexander Nagy, Santa Cruz, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Photon Dynamics, Inc., San Jose, CA (US)

(21) Appl. No.: 10/685,687

(22) Filed: Oct. 14, 2003

(51) Int. Cl. G02F 1/1334; G02F 1/135; G02F 1/13; G02F 1/1333; C03C 27/00; B32B 31/20

(52) U.S. Cl. 156/286; 156/285; 156/145; 349/199; 349/187; 349/86

(57) ABSTRACT

In an electro-optic light modulator requiring an electro-optical sensor material such as polymer dispersed liquid crystal, or PDLC is directly coated on an optical glass substrate with a transparent electrode, such as indium tin oxide (ITO) and an optional layer of passivation coating such as silicon dioxide (SiO₂) on its surface. A thin layer of polymeric adhesive is coated on top of PDLC layer and then this two-layer coating is laminated with a dielectric mirror on a polyester film (Mylar™) preferably with the assistance of a vacuum.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

This invention relates to electro-optical sensor material coatings for use in electro-optic applications. More particularly, this invention relates to direct PDLC (polymer dispersed liquid crystal) coating processes on a glass substrate.

Voltage imaging technology may be employed to detect and measure for defects in flat panel thin film transistor (TFT) arrays. According to this measurement technique, the performance of an array is simulated as if it were assembled into a TFT cell and then the characteristics of a TFT array are measured by indirectly measuring actual voltage distribution on the panel, or so-called voltage imaging, using an electro-optic (EO) light modulator-based detector.

A voltage imaging system in its most basic form includes an electro-optic (EO) modulator, an imaging objective lens, a charge coupled device (CCD) camera or other appropriate or similar sensor, and an image processor. The electro-optic sensor of the EO modulator is based on the light scattering characteristics of nematic liquid crystal droplets in a polymer matrix (polymer dispersed liquid crystal, or PDLC) film. In operation, the EO modulator is placed approximately 5-30 microns above the surface of a thin film transistor (TFT) array, and a voltage bias is applied across a transparent electrode of a layer of indium tin oxide (ITO) on a surface of the EO modulator. Thereupon, the EO modulator capacitively couples to the TFT array so that an electric field associated with the TFT array is sensed by the PDLC layer. Intensity of incident light transmitted through the PDLC layer is varied, i.e., is modulated, by any variations in the electric field strength across the liquid crystal (LC) material in the PDLC. This light is then reflected off a dielectric mirror and collected by the CCD camera or like sensor. A source of incident radiation, which may be for example infrared or visible light, is provided to illuminate the sandwich of TFT array, PDLC film and dielectric mirror.

The known method for EO modulator fabrication is use of commercial NCAP (nematic curvilinear aligned phase) material, which is a form of PDLC that is suitable for making very large area light valves and displays. The NCAP device consists of micron size droplets of liquid crystal dispersed in and surrounded by a polymer film, such as in a sandwich between two layers of ITO Mylar film. Two patents, assigned to Photon Dynamics Inc., describe such processes:

“Modulator Transfer Process and Assembly”, Michael A. Bryan, U.S. Pat. No. 6,151,153 (2000).

“Modulator Manufacturing Process and Device”, Michael A. Bryan, U.S. Pat. No. 6,211,991 B1 (2001).

The known modulator manufacturing processes involve laminating a sandwiched NCAP material on a glass substrate, trimming the sides, and making electrical connections from the side of the glass to the bottom ITO layer. The conventional lamination processes have the limitation of inconsistent surface flatness, mechanical instability, and extremely low yield in manufacture. Lamination requires a complicated assembly process, which contributes to lower yield and thus high cost for a finished EO modulator device. The cost of the tester contributes to the cost of testing, which is eventually reflected indirectly in the cost of finished products. What is needed is a structure and a technique to eliminate the NCAP film laminating and related processes.

### BRIEF SUMMARY OF THE INVENTION

According to the invention, in an electro-optic light modulator, a formulation of polymer dispersed liquid crystal (PDLC) is directly coated on an optical glass substrate which has on its surface a transparent electrode layer, such as indium tin oxide (ITO), and a passivation layer such as SiO₂, then a thin layer of polymeric adhesive is coated on top of the PDLC layer and then this two-layer coating is laminated with a dielectric mirror on a polyester film such as Mylar™. This process may be augmented with the assistance of a slight vacuum.

This invention eliminates the complicated process of lamination of NCAP film onto a substrate and provides a simplified process to fabricate modulators with excellent surface flatness, surface smoothness, mechanical stability and improved sensitivity. By direct control of liquid crystal composition, distribution and thickness, the manufacturing cost is significantly reduced and fabrication is simplified.

The invention will be better understood by reference to the following detailed description in connection with the accompanying drawings.

### BRIEF DESCRIPTION OF THE DRAWINGS

FIG. 1 is a schematic cutaway view of a device fabricated according to the invention.

FIG. 2 is a flow chart of an embodiment of the invention.

FIG. 3 is a schematic cutaway view of a vacuum chamber useful for laminating the dielectric mirror onto a layer of PDLC.

### DETAILED DESCRIPTION OF THE INVENTION

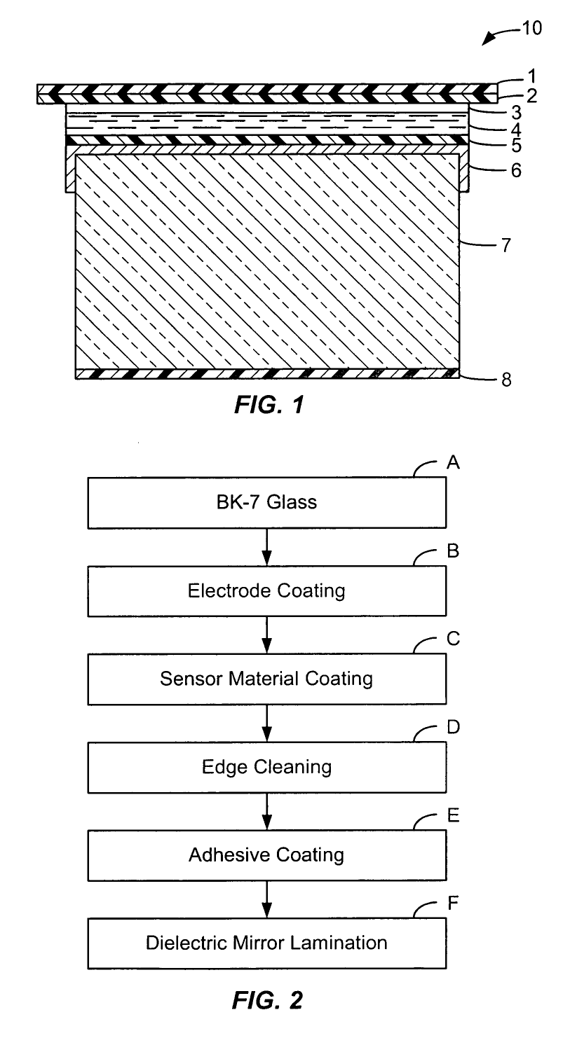

Referring to FIG. 1, there is shown an electro optic (EO) sensor 10 of an EO modulator fabricated in accordance with the invention. A polyester film layer 1, which is typically a thin Mylar™ film, provides substrate support for a dielectric mirror 2. The substrate/mirror combination is bonded via a thin layer of adhesive 3 to a layer of electro-optic sensor material, specifically a coating of polymer dispersed liquid crystal (PDLC) 4. The PDLC 4 is a directly applied coating on an optional layer of silicon dioxide 5. There is a layer of a transparent electro material, such as indium tin oxide (ITO 6) which in turn is bonded directly to an optical glass substrate 7, which is for example a block of type BK-7 optical glass. The glass substrate or block 7 is optically flat and has an antireflective coating 8 on the optically-smooth surface opposing the PDLC 4 surface.

Referring to FIG. 2, the process of fabricating the EO sensor 10 according to the invention is illustrated. The pre-step is the provision of the optical glass substrate 7, such as the block of BK-7 glass, which may be precoated with an antireflective layer 8 (Step A).

1) Electrode coating on optical glass substrate: As a first step in the fabrication process, an electrode coating is applied to the optical surface of the glass substrate 7 (Step B). Any conductive coating that is transparent at the wavelengths of interest can be used for this application. Indium tin oxide (ITO) is well-known and preferred. Optionally, as part of Step B, a layer of silicon dioxide (SiO₂) 4 may be overlaid on top of the conductive coating 6, which improves its durability, surface wetting properties, and adhesion with sensor materials 4. The electrode coating covers the top surface, two opposite edges and side surfaces for electrical connection.

2) Sensor material coating: The sensor material 4 is then applied over the electrode 6 (and optional silicon dioxide layer 7) (Step C). Any material with electro-optical response can be used. However, the preferred material includes polymer dispersed liquid crystal (PDLC), which is a gelatinous but potentially volatile liquid. Materials which are known to be suitable are designated as i) TL-205/AU1033; ii) TL-205/PMMA; ii) E7/poly(methyl methacrylate) (PMMA); and iv) E7/AU-1033. In the fabrication process, the following coating processes can be used: doctor blade, wired bar, slot die, spin, and meniscus. A process based on spin coating is preferred.

3) Edge cleaning: Thereafter, depending on the coating method, edge cleaning might be needed (Step D). It is preferred to use a plastic ‘knife’ (such as Mylar™ sheet not shown) to remove the edge without damaging the ITO coating on the edges.

4) Adhesive coating: Thereafter a thin adhesive film 3 is applied to the stack (Step E). Water-based adhesives must be used to coat on top of sensor material 4 to prevent damaging the sensor material surface. Such materials include polyurethane dispersions such as Neorez brand R-967 manufactured by Neoresins of Wilmington, Mass., acryl ate dispersions, and waterborne epoxies. The adhesives must be water based and may contain for example dispersions of silica or other low refractive index dielectric nanoparticles that are not chemically reactive in this context.

5) Dielectric mirror (“pellicle”) lamination: Finally, a dielectric stack 2 preformed on a thin polyester film 1 (such as 7 micron thick Mylar™) is applied by a lamination process on top of the adhesive layer 3 (Step F). A vacuum assisted lamination process is preferred, as explained below. The sides of the oversized pellicle 1, 2 (FIG. 1) may then be bent down and taped or otherwise fastened onto the substrate 7 to form the sensor plate, and electrode terminals can be connected to the ITO layer on the sides.

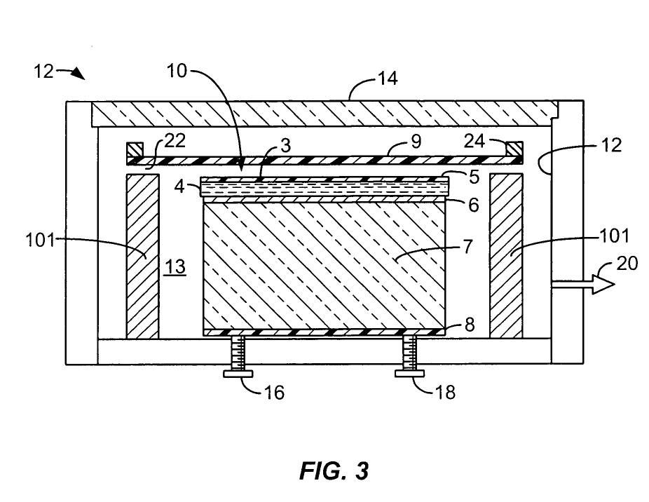

Referring FIG. 3, a suitable vacuum chamber 12 is depicted for use in the lamination process. The layers are exaggerated in height as depicted. The work-piece or EO sensor 10, comprising the glass block 7 with ITO layer 6, silicon dioxide layer 5, PDLC layer 4 and adhesive layer 3, is contained in the inner chamber 13, which is bounded by a positioning fixture 101 and which is in gas communication with a vacuum source 20. A pellicle 9 of dielectrically-coated polymer film 9 is mounted on an O-ring frame 24 and disposed to juxtapose the film 9 with the surface coated with the adhesive 3. The O-ring 24 may pinch the film 9 against posts of the fixture 101 with enough of a gap 22 to assure pressure equalization within the chamber. In the vacuum assisted process (Step F), the adjustment screws 16, 18 are automatically or manually advanced so that the adhesive layer 3 approaches the pellicle 9 and encounters it slightly off angle to the normal, so that only one side initially engages the pellicle. The block 7 is kept at this slight angle as it is pressed further against the stretchable pellicle 9, causing it to progressively engage the adhesive layer. The vacuum level, typically around one half atmosphere to about 0.8 atmosphere, and preferably about 0.75 atmosphere, prevents air bubbles from forming between the juxtaposed surfaces during lamination. The vacuum should not be so great as to cause excessive out gassing from volatile materials.

The foregoing is a simplified process compared with prior processes used to fabricate modulators. It yields a device with excellent surface flatness, surface smoothness, mechanical stability and improved sensitivity as compared with prior EO sensors. The manufacturing cost is significantly reduced due to choice of materials and simplified fabrication.

The invention has been explained with reference to specific embodiments. Other embodiments will be evident to those of ordinary skill in the art. It is therefore not intended that the invention be limited, except as indicated by the appended claims.

1. A method for fabricating an electro-optical sensor, said method comprising:
providing a glass substrate comprising an optically smooth top surface and an optically smooth bottom surface;
coating the top surfaces of the glass substrate with a transparent electrode;
applying a composition of electro-optic sensor material as a layer over the transparent electrode;
applying a thin layer of adhesive over the layer of the electro-optic sensor material layer; and
laminating a pellicle as a film bearing a dielectric mirror layer to the adhesive layer such that the dielectric mirror layer is substantially optically smooth against the electro-optic sensor material.

2. The method in claim 1, wherein said electro-optic sensor material is a polymer dispersed liquid crystal (PDLC).

3. The method according to claim 1 wherein the laminating step comprises performing the lamination in a vacuum.

4. The method according to claim 3 wherein the vacuum is less than 0.8 atmosphere.

5. The method according to claim 3 wherein the vacuum is between one-half atmosphere and 0.8 atmosphere.

6. The method according to claim 3 wherein the pellicle progressively engages the adhesive layer during the laminating step, the pellicle and the adhesive layer being disposed at an angle relative to one another.

7. The method according to claim 1 wherein the pellicle progressively engages the adhesive layer during the laminating step, the pellicle and the adhesive layer being disposed at an angle relative to one another.

8. The method according to claim 7 wherein the vacuum is between one-half atmosphere and 0.8 atmosphere.
